(19) United States
(12) Patent Application Publication
(10) Pub. No.: US 2010/0011722 A1
(43) Pub. Date: Jan. 21, 2010

(54) RESIDENCE CHAMBER FOR PRODUCTS OF COMBUSTION

(75) Inventor: Matthias Grundmann, York (GB)

Correspondence Address: GAUTHIER & CONNORS, LLP, 225 FRANKLIN STREET, SUITE 2300, BOSTON, MA, 02110, US

(73) Assignee: BIOFLAME LIMITED, Yorkshire (GB)

(21) Appl. No.: 12/535,301

(22) Filed: Aug. 4, 2009

Related U.S. Application Data
(63) Continuation of application No. PCT/GB2008/000655, filed on Feb. 27, 2008.

(30) Foreign Application Priority Data
Feb. 27, 2007 (GB) 0703769.0

(51) Int. Cl. B01D 45/08

(52) U.S. Cl. 55/392.1

(57) ABSTRACT

A residence chamber for use in treating products of combustion is disclosed. The chamber comprises a first chamber, having a gas inlet and a gas outlet, and a baffle. The baffle is located in the first chamber part and is arranged so as to cause gas entering the chamber through the inlet to travel initially in a first helical path and subsequently in a second helical path. The second helical path is in a second opposed axial direction and is inside the first helical path. The gas is arranged to exit the first chamber part through the outlet.

### PRIORITY

The present application is a continuation of and claims priority to Patent Cooperation Treaty Application PCT/GB2008/000655 filed Feb. 27, 2008, which claims priority to United Kingdom Patent Application No. GB 0703769.0 filed Feb. 27, 2007, the disclosures of which are each hereby incorporated by reference in their entireties.

### BACKGROUND

The present invention concerns a residence chamber for products of combustion.

Combustion products can include gases and particulates. Depending upon the combustion materials, the products of combustion may include toxic or environmentally hazardous gases and/or particulates. The presence of these unwanted by-products of combustion can present a problem to the burning of waste materials as fuel to generate heat and/or electricity.

For example, if previously used timber products, such as old railway sleepers, are to be burned as fuel it is likely that the timber will contain chemicals which were once used to preserve the timber. One such chemical, creosote, contains compounds which in combustion would be released as environmentally hazardous gases and/or particulates.

In view of this, regulations exist to ensure the safe burning of such materials. Typically such regulations stipulate that the products of combustion must remain confined in a vessel for a minimum period of time and at a minimum temperature, so that the gaseous compounds can be neutralised, or reacted to form as far as possible non-hazardous compounds, and particulates are broken down and filtered, before the gases are released into the atmosphere. Such vessels are often referred to as residence chambers.

Various types of residence chambers have been proposed. One previously considered residence chamber comprises a horizontally arranged vessel having an outlet at a remote end and an inlet at an end proximal to a combustion chamber, into which the products of combustion are introduced. As the hot gases follow a path from the inlet to the outlet the toxic gaseous compounds are broken down to minimise harmful impact when released into the atmosphere.

The prior art chambers of this kind have a number of disadvantages. Firstly, since environmental regulations require that products of combustion remain in the chamber for a minimum of two seconds at a minimum prescribed temperature, in order to ensure the requisite residence time the previously considered chamber is necessarily long—several tens of metres is not untypical—and the chamber may also require heating to ensure that the temperature of the gases does not fall below the required temperature as they flow towards the outlet.

Such a chamber takes up a great deal of space. Also, this arrangement is an inefficient use of the volume of the residence chamber, since the chamber contains a substantial quantity of unused space where the products of combustion do not reach.

There is a need therefore, for an improved residence chamber for treating products of combustion that avoids or substantially alleviates some or all of the aforementioned disadvantages.

### SUMMARY

Accordingly, embodiments of the present invention aim to provide a residence chamber for products of combustion in which some or all of the aforementioned disadvantages are at least partly alleviated.

According to one aspect of the present invention there is provided a residence chamber for use in treating products of combustion comprising: a first chamber part having a gas inlet and a gas outlet; and a baffle located in the first chamber part arranged so as to cause gas entering the chamber through the inlet to travel initially in a first helical path in a first axial direction and subsequently in a second helical path in a second opposed axial direction, the second helical path being inside the first helical path, wherein the gas is arranged to exit the first chamber part through the outlet.

The baffle may be attached to the bottom of the first chamber part, surround the outlet and extend in an axial direction. Preferably the baffle extends above the level of the inlet.

Preferably there is a second chamber part having an inlet and an outlet, the outlet of the first chamber part being in fluid communication with the inlet of the second chamber part.

The outlet of the first chamber part may be in axial alignment with the inlet of the second chamber part.

A duct may connect the outlet of the first chamber part and the inlet of the second chamber part.

Preferably the inner diameter of the duct is substantially the same as the diameter of the outlet of the first chamber part.

Preferably the inner diameter of the duct is substantially the same as the diameter of the inlet of the second chamber part.

The duct may extend axially into the first chamber part through the outlet and may substantially constitute the baffle.

In a preferred arrangement the inlet is located substantially tangentially with respect to the first helical path.

### BRIEF DESCRIPTION OF THE DRAWINGS

For a better understanding of the invention an embodiment of it will now be described, by way of example only, with reference to the accompanying drawings, in which:

FIG. 1 shows a schematic axial cross-sectional view of a first embodiment of the invention,

FIG. 2 shows a schematic perspective view of a first embodiment of the invention, and

FIG. 3 shows a schematic axial cross-sectional view of a second embodiment of the invention.

The drawings are shown for illustrative purposes only.

### DETAILED DESCRIPTION

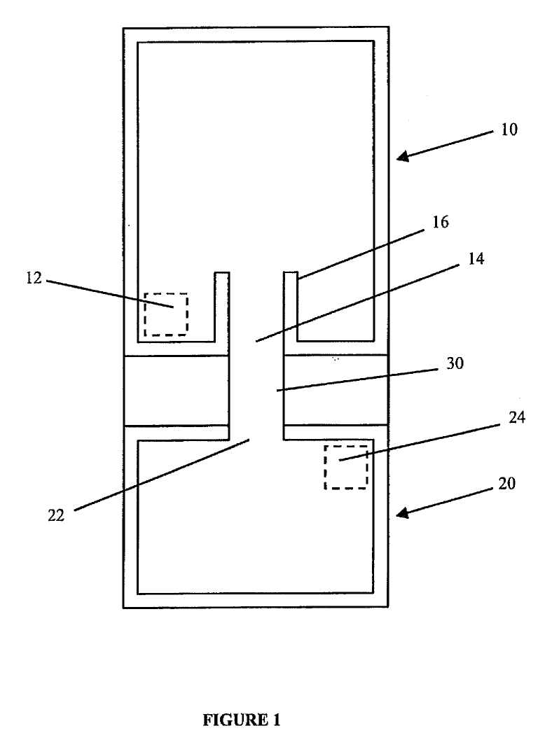

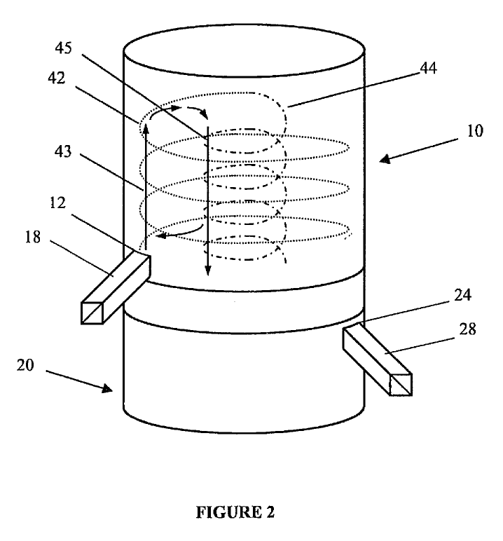

Referring to FIG. 1 and FIG. 2 the residence chamber 1 comprises a first chamber part 10 and a second chamber part 20. The first chamber and second chamber parts are cylindrical and are of substantially the same diameter. The first chamber 10 part is sealed at the top and has an axial opening 14 in the bottom. The second chamber part 20 is sealed at the bottom and has an axial opening 22 in the top. The axial openings 14, 22 of the first and second chamber parts 10, 20 are connected by an axially extending duct or conduit 30. The diameters of the axial openings 14, 22 in the first and second chamber parts 10, 20 and the inner diameter of the conduit 30 are substantially the same. The first chamber part 10 has a baffle 16 located in it. The baffle 16 is in the form of a cylindrical tube that extends in the axial direction and is fixed to the bottom of the chamber 10. The baffle 16 surrounds the axial opening 14.

Towards the bottom of the first chamber part 10 there is a tangential opening 12 to which is connected an inlet conduit 18. The tangential opening 12 is situated at an axial location that is lower than the top of the baffle 16. Towards the top of the second chamber part 20 there is also a tangential opening 24 to which is connected an outlet conduit 28.

In use, combustion gases enter the first chamber part 10 in a tangential direction through the inlet 12 via the inlet conduit 18. The configuration of the chamber 10, baffle 16 and the inlet 12 causes the gas initially to travel in a first generally helical path 42 in the upwards axial direction 43 (see FIG. 2). In particular, the baffle 16 acts as a vortex finder. As the gas reaches the upper part of the first chamber part 10 it is caused to travel in the downwards axial direction 45 in a second generally helical path 44 in order to find the outlet. The second helical path 44 is located inside the first helical path 42. The gas travels in the second helical path 44 through the inside of the baffle 16 and exits the first chamber part 10 through the axial outlet 14. The gas moves in a helical path through the conduit 30 and enters the second chamber part 20 through the axial inlet 22. The gas then travels in a helical path within the second chamber part 20 and exits the chamber through the tangential outlet 24 via the outlet conduit 28.

The use of a dual concentric helical flow path allows a reduction in the length of the chamber 10 whilst still ensuring that the combustion products travel within the chamber 10 for a sufficient length of time to comply with regulations. In addition, more of the space within the residence chamber is used which improves the volumetric efficiency of the chamber.

Also, as the combustion products follow the second, inner helical flow path 44, inevitably at higher velocity, any heavier particulates are thrown outwards by a centrifugal force into the outer helical flow path 42 until time, temperature and the violent movement of the gas flow causes them to decompose into smaller particulates.

Furthermore, because the chamber 10 need not be so long as previously considered ones, due to the concentric helices forming the flow path 42, 44, thermal losses from the walls of the chamber 10 are reduced, ensuring that the minimum temperature requirements can be met more easily with good insulation, and without requiring any additional heat to be supplied to the chamber.

Additionally, since the chamber may conveniently be positioned upright it takes up less of a “footprint” in a building.

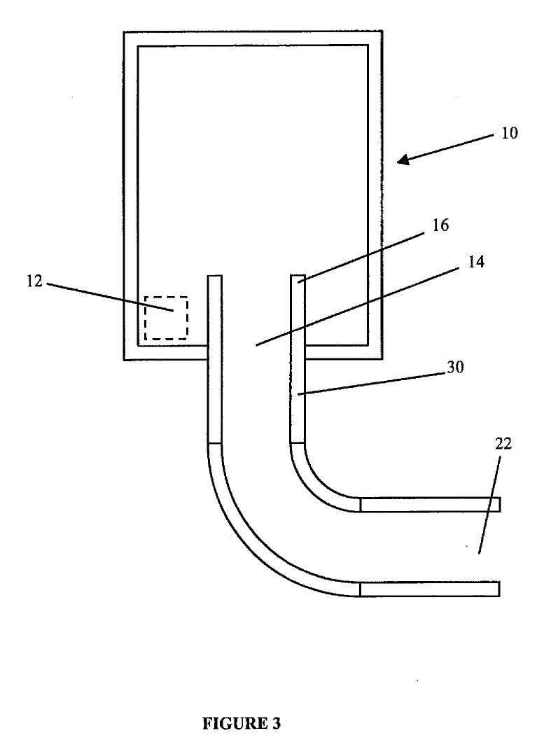

FIG. 3 illustrates a second embodiment of the invention. In this embodiment a tubular member constitutes the baffle 16 and the outlet 22. There is a right-angle bend in the tubular member so that the gas exits in the horizontal direction.

Those skilled in the art will appreciate that numerous modifications and variations may be made to the above disclosed embodiments without departing from the spirit and scope of the invention.

What is claimed is:

1. A residence chamber for use in treating products of combustion comprising:
a first chamber part having a gas inlet and a gas outlet; and
a baffle located in the first chamber part arranged so as to cause gas entering the chamber through the inlet to travel initially in a first helical path in a first axial direction and subsequently in a second helical path in a second opposed axial direction, the second helical path being inside the first helical path, wherein the gas is arranged to exit the first chamber part through the outlet.

2. A residence chamber according to claim 1, wherein the baffle is attached to the bottom of the first chamber part, surrounds the outlet and extends in an axial direction.

3. A residence chamber according to claim 1, wherein the baffle extends above the level of the inlet.

4. A residence chamber according to claim 1, further comprising a second chamber part having an inlet and an outlet, the outlet of the first chamber part being in fluid communication with the inlet of the second chamber part.

5. A residence chamber according to claim 4, wherein the outlet of the first chamber part is in axial alignment with the inlet of the second chamber part.

6. A residence chamber according to claim 4, wherein a duct connects the outlet of the first chamber part and the inlet of the second chamber part.

7. A residence chamber according to claim 6, wherein the inner diameter of the duct is substantially the same as the diameter of the outlet of the first chamber part.

8. A residence chamber according to claim 6, wherein the inner diameter of the duct is substantially the same as the diameter of the inlet of the second chamber part.

9. A residence chamber according to claim 1, wherein a duct extends axially into the first chamber portion through the outlet and substantially constitutes the baffle.

10. A residence chamber according to claim 1, wherein the inlet is located substantially tangentially with respect to the first helical path.
